(19) United States
(12) Patent Application Publication
(10) Pub. No.: US 2019/0356697 A1
(43) Pub. Date: Nov. 21, 2019

(54) METHODS AND APPARATUS TO ASSIGN SECURITY IN NETWORKED COMPUTING ENVIRONMENTS

(71) Applicant: NICIRA, INC., Palo Alto, CA (US)

(72) Inventors: VISHAL CHOUGULE, Pune (IN); NIKHIL BOKARE, Pune (IN); SUNITHA KRISHNA, Palo Alto, CA (US)

(21) Appl. No.: 16/019,575

(22) Filed: Jun. 27, 2018

(30) Foreign Application Priority Data
May 15, 2018 (IN) 201841018092

(51) Int. Cl. H04L 29/06; H04L 12/931; G06F 9/455

(52) U.S. Cl. CPC H04L 63/20; H04L 63/0227; G06F 2009/45595; G06F 9/45558; G06F 2009/45587; H04L 49/70

(57) ABSTRACT

Methods, apparatus, systems and articles of manufacture are disclosed for assigning security in networked computing environments. An example apparatus includes a deep packet inspector to: analyze a network communication from a virtual machine in a software defined network environment to determine an identifier of an application; and determine an application type executing on the virtual machine; a security controller to determine if a security group exists for the application type; and a user interface to present a recommendation to create a security group for the application type when a security group does not exist for the application type. The example security controller is further to add the virtual machine to the security group when the security group for the application type exists.

### RELATED APPLICATIONS

Benefit is claimed under 35 U.S.C. 119(a)-(d) to Foreign Application Serial No. 201841018092 filed in India entitled “METHODS AND APPARATUS TO ASSIGN SECURITY IN NETWORKED COMPUTING ENVIRONMENTS”, on May 15, 2018, by Nicira, Inc., which is herein incorporated in its entirety by reference for all purposes.

### FIELD OF THE DISCLOSURE

This disclosure relates generally to computing environments, and, more particularly, to methods and apparatus to assign security in networked computing environments.

### BACKGROUND

Virtualizing computer systems provides benefits such as the ability to: execute multiple computer systems on a single hardware computer, replicate computer systems, move computer systems among multiple hardware computers, and so forth. “Infrastructure-as-a-Service” (also commonly referred to as “IaaS”) generally describes a suite of technologies provided by a service provider as an integrated solution to allow for elastic creation of a virtualized, networked, and pooled computing platform (sometimes referred to as a “cloud computing platform”). Enterprises may use IaaS as a business-internal organizational cloud computing platform (sometimes referred to as a “private cloud”) that gives an application developer access to infrastructure resources, such as virtualized servers, storage, and networking resources. By providing ready access to the hardware resources required to run an application, the cloud computing platform enables developers to build, deploy, and manage the lifecycle of a web application (or any other type of networked application) at a greater scale and at a faster pace than ever before.

Cloud computing environments may be composed of many processing units (e.g., servers, computing resources, etc.). The processing units may be installed in standardized frames, known as racks, which provide efficient use of floor space by allowing the processing units to be stacked vertically. The racks may additionally include other components of a cloud computing environment such as storage devices, networking devices (e.g., routers, switches, etc.), etc.

In recent years, networked computing environments such as virtualized computing environments, physical computing environments, and hybrid computing environments, have grown in power and also complexity. One such type of networked computing environment is a cloud computing environment. A cloud computing environment includes physical and virtualized computing resources that are located at one or multiple locations and may be accessed by a client (e.g., a customer) via a network (e.g., the Internet).

### BRIEF DESCRIPTION OF THE DRAWINGS

FIG. 1 depicts an example system constructed in accordance with the teachings of this disclosure for managing a computing platform (e.g., a cloud computing platform and/or other distributed computing platform, etc.).

FIG. 2 is a block diagram of an example implementation of the virtual networking layer of FIG. 1.

FIG. 3 is a flowchart representative of machine readable instructions which may be executed to implement the example virtual networking layer of FIG. 1 and/or FIG. 2.

FIG. 4 is a block diagram of an example processing platform structured to execute the instructions of FIG. 3 to implement the example virtual networking layer of FIG. 1 and/or FIG. 2.

### DETAILED DESCRIPTION

As the complexity of cloud computing environments has grown, the complexity of managing security in such environments and other computing environments has increased. For example, in environments where computing elements (e.g., virtual computing elements and physical computing elements) are frequently added or removed from a computing environment and modified (e.g., services executed by the computing environment are changed), it may be difficult for an administrator to create, assign, and update security settings, group policies, machine policies, firewall rules, etc. Methods and apparatus disclosed here facilitate the assignment of security policies using information obtained from deep packet inspection of packets transmitted by computing elements. For example, an application executing on a computing element may be detected (e.g., a database application, a web server application, a messaging application, etc.) using deep packet inspection of packets (e.g., three to nine packets) from a computing element to identify the application protocol generated by the computing element and a security policy (e.g., assignment to a security group) may be assigned to the computing element based on the detected application.

Virtual computing is based on the deployment of many physical resources across a network, virtualizing the physical resources into virtual resources, and provisioning the virtual resources to perform computing services and applications. Example systems for virtualizing computer systems are described in U.S. patent application Ser. No. 11/903,374, entitled “METHOD AND SYSTEM FOR MANAGING VIRTUAL AND REAL MACHINES,” filed Sep. 21, 2007, and granted as U.S. Pat. No. 8,171,485, U.S. Provisional Patent Application No. 60/919,965, entitled “METHOD AND SYSTEM FOR MANAGING VIRTUAL AND REAL MACHINES,” filed Mar. 26, 2007, and U.S. Provisional Patent Application No. 61/736,422, entitled “METHODS AND APPARATUS FOR VIRTUALIZED COMPUTING,” filed Dec. 12, 2012, all three of which are hereby incorporated herein by reference in their entirety.

A virtual machine is a software computer that, like a physical computer, runs an operating system and applications. An operating system installed on a virtual machine is referred to as a guest operating system. Because each virtual machine is an isolated computing environment, virtual machines (VMs) can be used as desktop or workstation environments, as testing environments, to consolidate server applications, etc. Virtual machines can run on hosts or clusters. The same host can run a plurality of VMs, for example.

A management cluster is a group of physical machines and virtual machines (VM) that host core cloud infrastructure components necessary for managing a software defined data center (SDDC) in a cloud computing environment that supports customer services. Cloud computing allows ubiquitous, convenient, on-demand network access to a shared pool of configurable computing resources. A cloud computing customer can request allocations of such resources to support services required by those customers. For example, when a customer requests to run one or more services in the cloud computing environment, one or more workload domains may be created based on resources in the shared pool of configurable computing resources.

Virtual networks can be used with virtual machines in SDDC and/or other cloud or cloud-like computing environments. Virtual networks can be managed (e.g., using NSX sold by VMware, Inc.) using policies and rules. Network and other infrastructure is configured for consumption by applications. Virtual network(s) are provisioned for such applications to be deployed in the SDDC.

Manual configuration of Open Systems Interconnect (OSI) network layers (e.g., Layer 1 (L1), Layer 2 (L2), Layer 3 (L3), etc.) and associated individual services, including distributed firewall (DFW), load balancing (LB), etc., is a complicated and time-consuming series of tasks. Then, the application VM must be placed in the L2/L3 network. Certain examples streamline and improve such network and service configuration and application VM placement by defining applications in the policy or management layer. Certain examples described herein define an application entity in the policy/management layer. An application entity is a logical manageable entity that includes a group of VMs on which the application will be executing.

Certain examples create logical overlay networks such that any two VMs, each being at any arbitrary location in the entire datacenter (and possible across multiple datacenters) can think that they are on the same physical network connected by a single switch between them. Such as logical overlay network is implemented by a network tunnel that is established between the hosts on which the two VMs reside. When the first VM sends out a packet to the second VM, its L2 header is encapsulated by an L3 header addressed to the second host, and then another L2 header for the first hop towards that second host. The destination host then decapsulates the packet and gives the inner, original packet to the second VM. The encapsulation, decapsulation, and exchange are orchestrated by a central controller cluster which knows where each VM is and translates logical switch configuration to physical switch configurations for programming a physical forwarding plane with instructions to encapsulate and forward the packet according to the translations. A management server receives user configuration inputs such as logical network configuration and communicates this to the controller cluster via application programming interfaces (APIs). The controller cluster also handles higher-level constructs such as logical L3 routers, which are each distributed across the hosts that have VMs that are connected to the logical router. Each logical router can perform functions of a physical router, including NAT, SNAT, ACL, etc. Firewalls, load balancers, etc., can be implemented, and firewall rules can be applied at each port of the virtual switch according to configurations. In certain examples, policy rules can be translated into firewall rules using context information. Firewall rules can be used to regulate access, permission, etc.

Example Virtualization Environments

Many different types of virtualization environments exist. Three example types of virtualization environment are: full virtualization, paravirtualization, and operating system virtualization.

Full virtualization, as used herein, is a virtualization environment in which hardware resources are managed by a hypervisor (e.g., a virtual machine monitor (VMM) and/or other software, hardware, and/or firmware to create and execute virtual machines) to provide virtual hardware resources to a virtual machine. A computer or other computing device on which the hypervisor runs is referred to as a host machine or host computer, and each virtual machine running on the host machine is referred to as a guest machine. The hypervisor provides guest operating systems with a virtual operating platform and manages execution of the guest operating systems. In certain examples, multiple operating system instances can share virtualized hardware resources of the host computer.

In a full virtualization environment, the virtual machines do not have direct access to the underlying hardware resources. In a typical full virtualization environment, a host operating system with embedded hypervisor (e.g., VMware ESXi®) is installed on the server hardware. Virtual machines including virtual hardware resources are then deployed on the hypervisor. A guest operating system is installed in the virtual machine. The hypervisor manages the association between the hardware resources of the server hardware and the virtual resources allocated to the virtual machines (e.g., associating physical random access memory (RAM) with virtual RAM). Typically, in full virtualization, the virtual machine and the guest operating system have no visibility and/or direct access to the hardware resources of the underlying server. Additionally, in full virtualization, a full guest operating system is typically installed in the virtual machine while a host operating system is installed on the server hardware. Example full virtualization environments include VMware ESX®, Microsoft Hyper-V®, and Kernel Based Virtual Machine (KVM).

Paravirtualization, as used herein, is a virtualization environment in which hardware resources are managed by a hypervisor to provide virtual hardware resources to a virtual machine and guest operating systems are also allowed direct access to some or all of the underlying hardware resources of the server (e.g., without accessing an intermediate virtual hardware resource). In a typical paravirtualization system, a host operating system (e.g., a Linux-based operating system) is installed on the server hardware. A hypervisor (e.g., the Xen® hypervisor) executes on the host operating system. Virtual machines including virtual hardware resources are then deployed on the hypervisor. The hypervisor manages the association between the hardware resources of the server hardware and the virtual resources allocated to the virtual machines (e.g., associating physical random access memory (RAM) with virtual RAM). In paravirtualization, the guest operating system installed in the virtual machine is configured also to have direct access to some or all of the hardware resources of the server. For example, the guest operating system may be precompiled with special drivers that allow the guest operating system to access the hardware resources without passing through a virtual hardware layer. For example, a guest operating system may be precompiled with drivers that allow the guest operating system to access a sound card installed in the server hardware. Directly accessing the hardware (e.g., without accessing the virtual hardware resources of the virtual machine) may be more efficient, may allow for performance of operations that are not supported by the virtual machine and/or the hypervisor, etc.

Operating system virtualization is also referred to herein as container virtualization. As used herein, operating system virtualization refers to a system in which processes are isolated in an operating system. In a typical operating system virtualization system, a host operating system is installed on the server hardware. Alternatively, the host operating system may be installed in a virtual machine of a full virtualization environment or a paravirtualization environment. The host operating system of an operating system virtualization system is configured (e.g., utilizing a customized kernel) to provide isolation and resource management for processes that execute within the host operating system (e.g., applications that execute on the host operating system). The isolation of the processes is known as a container. Several containers may share a host operating system. Thus, a process executing within a container is isolated the process from other processes executing on the host operating system. Thus, operating system virtualization provides isolation and resource management capabilities without the resource overhead utilized by a full virtualization environment or a paravirtualization environment. Alternatively, the host operating system may be installed in a virtual machine of a full virtualization environment or a paravirtualization environment. Example operating system virtualization environments include Linux Containers LXC and LXD, Docker™, OpenVZ™, etc.

In some instances, a data center (or pool of linked data centers) may include multiple different virtualization environments. For example, a data center may include hardware resources that are managed by a full virtualization environment, a paravirtualization environment, and an operating system virtualization environment. In such a data center, a workload may be deployed to any of the virtualization environments.

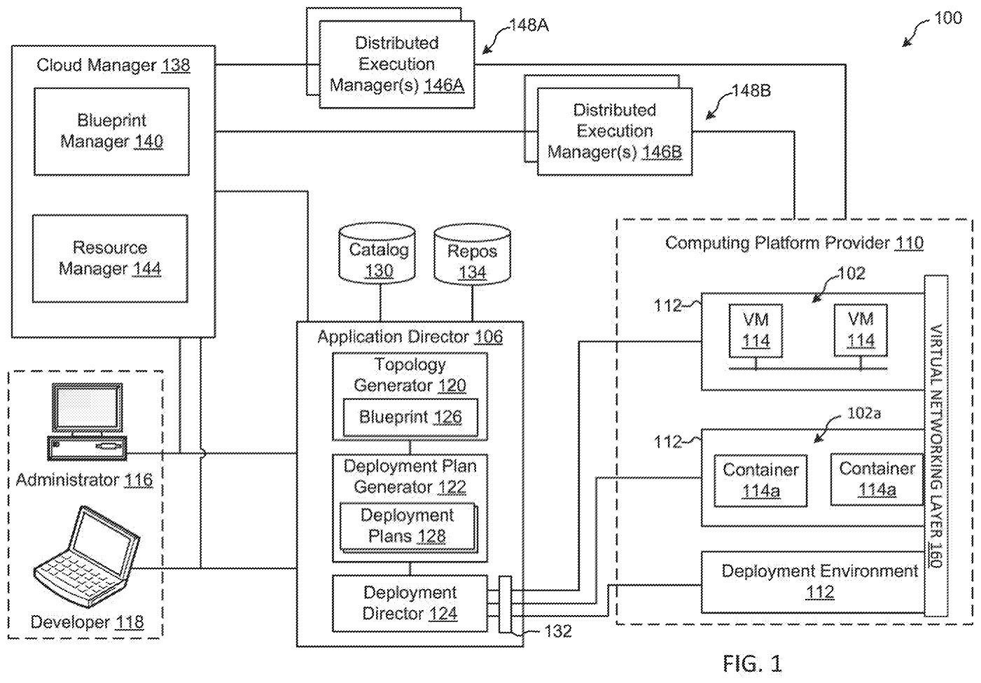

FIG. 1 depicts an example system 100 constructed in accordance with the teachings of this disclosure for managing a computing platform (e.g., a cloud computing platform and/or other distributed computing platform, etc.). The example system 100 includes an application director 106 and a manager 138 to manage a computing platform provider 110 as described in more detail below. As described herein, the example system 100 facilitates management of the provider 110 and does not include the provider 110. Alternatively, the system 100 can be included in the provider 110.

The computing platform provider 110 provisions virtual computing resources (e.g., virtual machines, or “VMs,” 114) that may be accessed by users of the computing platform 110 (e.g., users associated with an administrator 116 and/or a developer 118) and/or other programs, software, device. etc.

An example application 102 implemented via the computing platform provider 110 of FIG. 1 includes multiple VMs 114. The example VMs 114 of FIG. 1 provide different functions within the application 102 (e.g., services, portions of the application 102, etc.). One or more of the VMs 114 of the illustrated example are customized by an administrator 116 and/or a developer 118 of the application 102 relative to a stock or out-of-the-box (e.g., commonly available purchased copy) version of the services and/or application components. Additionally, the services executing on the example VMs 114 may have dependencies on other ones of the VMs 114.

As illustrated in FIG. 1, the example computing platform provider 110 may provide multiple deployment environments 112, for example, for development, testing, staging, and/or production of applications. The administrator 116, the developer 118, other programs, and/or other devices may access services from the computing platform provider 110, for example, via REST (Representational State Transfer) APIs (Application Programming Interface) and/or via any other client-server communication protocol. Example implementations of a REST API for cloud and/or other computing services include a vCloud Administrator Center™ (vCAC) and/or vRealize Automation™ (vRA) API and a vCloud Director™ API available from VMware, Inc. The example computing platform provider 110 provisions virtual computing resources (e.g., the VMs 114) to provide the deployment environments 112 in which the administrator 116 and/or the developer 118 can deploy multi-tier application(s). One particular example implementation of a deployment environment that may be used to implement the deployment environments 112 of FIG. 1 is vCloud DataCenter cloud computing services available from VMware, Inc.

In some examples disclosed herein, a lighter-weight virtualization is employed by using containers in place of the VMs 114 in the development environment 112. Example containers 114a are software constructs that run on top of a host operating system without the need for a hypervisor or a separate guest operating system. Unlike virtual machines, the containers 114a do not instantiate their own operating systems. Like virtual machines, the containers 114a are logically separate from one another. Numerous containers can run on a single computer, processor system and/or in the same development environment 112. Also like virtual machines, the containers 114a can execute instances of applications or programs (e.g., an example application 102a) separate from application/program instances executed by the other containers in the same development environment 112.

The example application director 106 of FIG. 1, which may be running in one or more VMs, orchestrates deployment of multi-tier applications onto one of the example deployment environments 112. As illustrated in FIG. 1, the example application director 106 includes a topology generator 120, a deployment plan generator 122, and a deployment director 124.

The example topology generator 120 generates a basic blueprint 126 that specifies a logical topology of an application to be deployed. The example basic blueprint 126 generally captures the structure of an application as a collection of application components executing on virtual computing resources. For example, the basic blueprint 126 generated by the example topology generator 120 for an online store application may specify a web application (e.g., in the form of a Java web application archive or “WAR” file including dynamic web pages, static web pages, Java servlets, Java classes, and/or other property, configuration and/or resources files that make up a Java web application) executing on an application server (e.g., Apache Tomcat application server) that uses a database (e.g., MongoDB) as a data store. As used herein, the term “application” generally refers to a logical deployment unit, including one or more application packages and their dependent middleware and/or operating systems. Applications may be distributed across multiple VMs. Thus, in the example described above, the term “application” refers to the entire online store application, including application server and database components, rather than just the web application itself. In some instances, the application may include the underlying hardware and/or virtual computing hardware utilized to implement the components.

The example basic blueprint 126 of FIG. 1 may be assembled from items (e.g., templates) from a catalog 130, which is a listing of available virtual computing resources (e.g., VMs, networking, storage, etc.) that may be provisioned from the computing platform provider 110 and available application components (e.g., software services, scripts, code components, application-specific packages) that may be installed on the provisioned virtual computing resources. The example catalog 130 may be pre-populated and/or customized by an administrator 116 (e.g., IT (Information Technology) or system administrator) that enters in specifications, configurations, properties, and/or other details about items in the catalog 130. Based on the application, the example blueprints 126 may define one or more dependencies between application components to indicate an installation order of the application components during deployment. For example, since a load balancer usually cannot be configured until a web application is up and running, the developer 118 may specify a dependency from an Apache service to an application code package.

The example deployment plan generator 122 of the example application director 106 of FIG. 1 generates a deployment plan 128 based on the basic blueprint 126 that includes deployment settings for the basic blueprint 126 (e.g., virtual computing resources' cluster size, CPU, memory, networks, etc.) and an execution plan of tasks having a specified order in which virtual computing resources are provisioned and application components are installed, configured, and started. The example deployment plan 128 of FIG. 1 provides an IT administrator with a process-oriented view of the basic blueprint 126 that indicates discrete actions to be performed to deploy the application. Different deployment plans 128 may be generated from a single basic blueprint 126 to test prototypes (e.g., new application versions), to scale up and/or scale down deployments, and/or to deploy the application to different deployment environments 112 (e.g., testing, staging, production). The deployment plan 128 is separated and distributed as local deployment plans having a series of tasks to be executed by the VMs 114 provisioned from the deployment environment 112. Each VM 114 coordinates execution of each task with a centralized deployment module (e.g., the deployment director 124) to ensure that tasks are executed in an order that complies with dependencies specified in the application blueprint 126.

The example deployment director 124 of FIG. 1 executes the deployment plan 128 by communicating with the computing platform provider 110 via an interface 132 to provision and configure the VMs 114 in the deployment environment 112. The example interface 132 of FIG. 1 provides a communication abstraction layer by which the application director 106 may communicate with a heterogeneous mixture of provider 110 and deployment environments 112. The deployment director 124 provides each VM 114 with a series of tasks specific to the receiving VM 114 (herein referred to as a “local deployment plan”). Tasks are executed by the VMs 114 to install, configure, and/or start one or more application components. For example, a task may be a script that, when executed by a VM 114, causes the VM 114 to retrieve and install particular software packages from a central package repository 134. The example deployment director 124 coordinates with the VMs 114 to execute the tasks in an order that observes installation dependencies between VMs 114 according to the deployment plan 128. After the application has been deployed, the application director 106 may be utilized to monitor and/or modify (e.g., scale) the deployment.

The example manager 138 of FIG. 1 interacts with the components of the system 100 (e.g., the application director 106 and the provider 110) to facilitate the management of the resources of the provider 110. The example manager 138 includes a blueprint manager 140 to facilitate the creation and management of multi-machine blueprints and a resource manager 144 to reclaim unused cloud resources. The manager 138 may additionally include other components for managing a cloud environment.

The example blueprint manager 140 of the illustrated example manages the creation of multi-machine blueprints that define the attributes of multiple virtual machines as a single group that can be provisioned, deployed, managed, etc. as a single unit. For example, a multi-machine blueprint may include definitions for multiple basic blueprints that make up a service (e.g., an e-commerce provider that includes web servers, application servers, and database servers). A basic blueprint is a definition of policies (e.g., hardware policies, security policies, network policies, etc.) for a single machine (e.g., a single virtual machine such as a web server virtual machine and/or container). Accordingly, the blueprint manager 140 facilitates more efficient management of multiple virtual machines and/or containers than manually managing (e.g., deploying) basic blueprints individually.

The example blueprint manager 140 of FIG. 1 additionally annotates basic blueprints and/or multi-machine blueprints to control how workflows associated with the basic blueprints and/or multi-machine blueprints are executed. As used herein, a workflow is a series of actions and decisions to be executed in a virtual computing platform. The example system 100 includes first and second distributed execution manager(s) (DEM(s)) 146A and 146B to execute workflows. According to the illustrated example, the first DEM 146A includes a first set of characteristics and is physically located at a first location 148A. The second DEM 146B includes a second set of characteristics and is physically located at a second location 148B. The location and characteristics of a DEM may make that DEM more suitable for performing certain workflows. For example, a DEM may include hardware particularly suited for performance of certain tasks (e.g., high-end calculations), may be located in a desired area (e.g., for compliance with local laws that require certain operations to be physically performed within a country's boundaries), may specify a location or distance to other DEMS for selecting a nearby DEM (e.g., for reducing data transmission latency), etc. Thus, the example blueprint manager 140 annotates basic blueprints and/or multi-machine blueprints with capabilities that can be performed by a DEM that is labeled with the same or similar capabilities.

The resource manager 144 of the illustrated example facilitates recovery of computing resources of the provider 110 that are no longer being activity utilized. Automated reclamation may include identification, verification and/or reclamation of unused, underutilized, etc. resources to improve the efficiency of the running cloud infrastructure.

Returning to the example computing platform provider 110, the example computing platform provider 110 includes a virtual networking layer 160. Software-defined networking (SDN) provides computer networks in which network behavior can be programmatically initialized, controlled, changed, and managed dynamically via open interface(s) and abstraction of lower-level functionality. As with VMs, SDN or network virtualization addresses the problem that the static architecture of traditional networks does not support the dynamic, scalable computing and storage needs of more modern computing environments such as data centers. By dividing a network into a set of planes (e.g., control plane, data plane, management or policy plane, etc., a system that determines where network traffic is sent (e.g., an SDN controller, or control plane) can be separated from underlying systems that forward traffic to the selected destination (e.g., the data plane, etc.).

In a network, a plane is an architectural component or area of operation for the network. Each plane accommodates a different type of data traffic and runs independently on top of the network hardware infrastructure. The data plane (sometimes also referred to as the user plane, forwarding plane, carrier plane, or bearer plane) carries network user traffic. The control plane carries signaling data traffic. Control packets carried by the control plane originate from or are destined for a router, for example. The management or policy plane, which carries administrative data traffic, is considered a subset of the control plane.

In conventional networking, the three planes are implemented in the network firmware of routers and switches. SDN with the virtual networking layer 160 decouples the data and control planes to implement the control plane in software rather than network hardware. Software implementation if the example virtual networking layer 160 enables programmatic access and adds flexibility to network administration. For example, network traffic can be shaped via the control plane from a centralized control console without having to adjust individual network switches. Additionally, switch rules can be dynamically adjusted such as to prioritize, de-prioritize, block, etc., certain packet types, etc.

According to the illustrated example, the virtual networking layer 160 associates each network plane with one or more data transfer/communication protocols. For example, interfaces, Internet Protocol (IP) subnets and routing protocols are configured through management plane protocols (e.g., Command Line Interface (CLI), Network Configuration Protocol (NETCONF), Representational State Transfer (RESTful) application programming interface (API), etc.). In certain examples, a router runs control plane routing protocols (e.g., OSPF, EIGRP, BGP, etc.) to discover adjacent devices and network topology information. The router inserts the results of the control-plane protocols into table(s) such as a Routing Information Base (RIB), a Forwarding Information Base (FIB), etc. Data plane software and/or hardware (e.g., application specific integrated circuits (ASICs), field programmable gate arrays (FPGAs), etc.) use FIB structures to forward data traffic on the network. Management/policy plane protocols, such as Simple Network Management Protocol (SNMP), can be used to monitor device operation, device performance, interface counter(s), etc.

The example virtual networking layer 160 decouples the hardware plane from the software plane such that the host hardware plane can be administratively programmed to assign its resources to the software plane. Such programming allows for virtualization of central processing unit (CPU) resources, memory, other data storage, network input/output (IO) interface, and/or other network hardware resource. Virtualization of hardware resources facilitates implementation of a plurality of virtual network applications such as firewalls, routers, Web filters, intrusion prevention systems, etc., contained within a single hardware appliance. Thus, logical or “virtual” networks can be created on top of a physical network, and the virtual networks can have the same properties as the underlying physical network.

Within the example virtual networking layer 160, applications are interconnected by a virtual switch, rather than a physical, hardware-based network switch. Virtual switches are software-based “switches” that involve movement of packets up and down a software stack which relies on the same processor(s) that are being used to drive the applications. The virtual switch (also referred to as a soft switch or vSwitch) can be implemented on each server in a virtual network, and packets can be encapsulated across multiple vSwitches that forward data packets in a network overlay on top of a physical network as directed by a network controller that communicates to the vSwitch via a protocol such as OpenFlow, etc.

Thus, in a close analogy to a virtual machine, the example virtual networking layer 160 is a software container that presents logical network components (e.g., logical switches, routers, firewalls, load balancers, virtual private networks (VPNs), etc.) to connected workloads. The virtualized networks are programmatically created, provisioned and managed, with the underlying physical network serving as a simple packet-forwarding backplane for data traffic on the virtual network. Network and security services are allocated to each VM according to its needs, and stay attached to the VM as the VM moves among hosts in the dynamic virtualized environment. The example virtual networking layer 160 (e.g., VMware's NSX, etc.) deploys on top of existing physical network hardware and supports fabrics and geometries from a plurality of vendors. In certain examples, applications and monitoring tools work smoothly with the example virtual networking layer 160 without modification.

In certain examples, the example virtual networking layer 160 introduces a new address space enabling logical networks to appear as physical networks. For example, even if the physical network is L3 (Layer 3), an L2 (Layer 2) virtual network can be created. As another example, if the physical network is L2, an L3 virtual network can be created. When a data packet leaves a VM, for example, the packet is sent to the physical network via lookup from the virtual network. The packet can then be transported back from the physical network to the virtual network for further computation and/or other processing at its destination (e.g., virtual network address spaces can be mapped to a physical address space along a network edge in real time or substantially real time given system processing, transmission, and/or data storage latency, etc.). Thus, the virtual network is decoupled from the physical network. An abstraction layer is created and managed between end systems and the physical network infrastructure which enables creation of logical networks that are independent of the network hardware.

For example, two VMs located at arbitrary locations in a data center (and/or across multiple data centers, etc.) can be connected by a logical overlay networks such that the two VMs think that they are on the same physical network connected by a single switch between the VMs. The overlay network is implemented by a network tunnel that is established between the host computers on which the two VMs reside. When the first VM sends out a packet to the second VM, the packet's L2 header is encapsulated by an L3 header addressed to the second host, and then another L2 header is generated for the first hop toward the second host for the second VM (e.g., the destination host). The destination host then unpackages the packet and provides the inner, original packet to the second VM. Routing from the first VM to the second VM can be orchestrated by a central controller cluster which knows a location for each VM and translates logical switch configuration to physical switch configuration to program the physical forwarding plane with instructions to encapsulate and forward the packet according to the translation(s). A management server receives user configuration input, such as logical network configuration, and communicates the input to the controller cluster via one or more APIs, for example.

The controller cluster also handles higher-level constructs such as logical L3 routers, which are distributed across the hosts that have VMs that are connected to the logical router. Each logical router can include capabilities of physical routers, including network address translation (NAT), secure NAT (SNAT), access control list (ACL), etc. The controller cluster can also implement distributed firewalls, load balancers, etc. Firewall rules can be applied at each port of the virtual switch according to a configuration, for example.

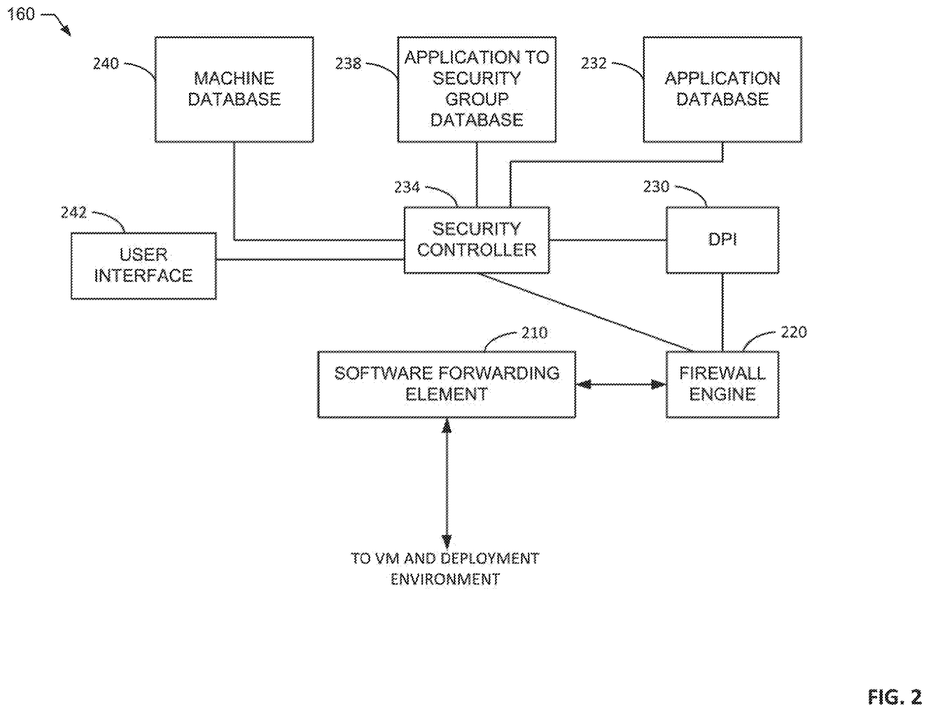

The example virtual networking layer 160 utilizes deep packet inspection of packets transmitted within the virtual networking layer 160 by virtual machines or other computing elements to identify applications execution on the virtual machines or other computing elements. The example virtual networking layer 160 utilizes the application identification information to direct the assignment of security groups (e.g., security groups that define firewall policies, data access restrictions, etc.) to the virtual machines or other computing elements. Further detail of the virtual networking layer 160 is described in conjunction with FIG. 2.

FIG. 2 is a block diagram of an example implementation of the virtual networking layer 160. The example network virtualization layer 160 of FIG. 2 includes a software forwarding element 210, a firewall engine 220, a deep packet inspector 230, an application database 232, an example security controller 234, an example application to security group database 238, an example machine database 240, and an example user interface 242.

The software forwarding element 210 of the illustrated example implements virtual networking elements to communicatively couple computing elements such as the virtual machine 114 via a software defined network/virtual network. For example, the software forwarding element 210 may implement a virtual router, a virtual switch, a virtual wide area network, a virtual local area network, etc. For simplicity, known components of a virtual networking system of the software forwarding element 210 are not described in further detail. Network traffic within the example software forwarding element is selectively routed through the example firewall engine 220. For example, an administrator may choose which network connections are routed through the example firewall engine 220.

The example firewall engine 220 performs firewall operations on data messages sent by or received through the software forwarding element. The firewall operations are based on firewall rules stored in the firewall engine 220. Some of the firewall rules are defined based on layer 2-layer 4 attributes (e.g., in terms of five-tuple identifiers. The example firewall engine applies firewall rules to component elements (e.g., the virtual machines 114) based on instructions from the example security controller 234. For example, the security controller 234 may instruct the example firewall engine 220 to apply a first set of policies to a network connection of a first one of the virtual machines 114 and to apply a second set of policies to a network connecting of a second one of the virtual machines 114.

The example deep packet inspector 230 is coupled to the firewall engine 220 to analyze traffic that flows through the example firewall engine 220. When the example firewall engine 220 receives a new data message that is part of a new data message flow, the firewall engine 220 directs the deep packet inspector 230 to inspect the new data message and one or more of the next few data messages in the same flow. Based on the examination, the deep packet inspector 230 identifies the type of traffic (e.g., an application protocol) that is being sent in the data message flow. The example deep packet inspector 230 accesses the example application database 232 to identify an application associated with the type of traffic. For example, the deep packet inspector may detect SQL traffic and the application database 232 may indicate that such traffic is associated with a database application. The example deep packet inspector 230 reports the identified application and the source of the messages (e.g., the virtual machine 114 from which the traffic originated) to the example security controller 234.

The example security controller 234 receives application identified traffic from the example deep packet inspector 234 and determines whether a security policy is to be applied to the virtual machine 114 from which the traffic originated. According to the illustrated example, the security controller 234 queries the example application to security group database 238 to determine if a security policy and/or security group has been created for the identified type of application. A security group is a logical grouping of computing elements that share the same security policy(ies). A change to a security group (e.g., addition, removal, and/or modification of a policy for a security group) is applicable to all computing elements assigned to the security group. For example, the application to security group database 238 may indicate a security policy and/or a security group that is to be assigned to computing elements that provide database services. When a policy and/or security group associated with the application type is identified in the example application to security group database 238, the example security controller 234 stores an association of the policy and/or security group with an identification of the computing element (e.g., a network address, a machine name, a machine identification number, etc.) in the example machine database 240 and instructs the example firewall engine 220 to apply the policy and/or security group. Additionally or alternatively, the example security controller 234 may instruct other elements of a system to apply the security policy and/or security group (e.g., a storage controller, a user access interface, etc.). However, when a policy and/or security group associated with the application type is not identified in the example application to security group database 238, the example security controller prompts a user via the example user interface 242 to create a security policy and/or security group for the application type.

The example user interface 242 provides a user interface for a user (e.g., an administrator) to consider security policies for assignment by the example security controller 234. When a security policy and/or security group is not identified an application type, the example user interface 242 presents a recommendation for creating a security policy and/or security group and provides an interface for inputting the new policy. The example user interface 242 additionally presents a user interface for a user to modify existing policies and/or security groups associated with an application.

The example application database 232, application to security group database 238, and the example machine database 240 may be implemented by any type(s) of storage structures. For example, the databases 232, 238, and/or 240 may be a database(s), a file(s), a list(s), a look-up-table(s), etc. While three databases are included in the illustrated example, the databases 232, 238, and/or 240 may be combined and/or divided.

While an example manner of implementing the virtual networking layer 160 of FIG. 1 is illustrated in FIG. 2, one or more of the elements, processes and/or devices illustrated in FIG. 2 may be combined, divided, re-arranged, omitted, eliminated and/or implemented in any other way. Further, the example software forwarding element 210, the example firewall engine 220, the example deep packet inspector 230, the example application database 232, the example security controller 234, the example application to security group database 238, the example machine database 240, the example user interface 242, and/or more generally, the example virtual networking layer 160 of FIG. 2 may be implemented by hardware, software, firmware and/or any combination of hardware, software and/or firmware. Thus, for example, any of the example software forwarding element 210, the example firewall engine 220, the example deep packet inspector 230, the example application database 232, the example security controller 234, the example application to security group database 238, the example machine database 240, the example user interface 242, and/or more generally, the example virtual networking layer 160 of FIG. 2 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example software forwarding element 210, the example firewall engine 220, the example deep packet inspector 230, the example application database 232, the example security controller 234, the example application to security group database 238, the example machine database 240, the example user interface 242, and/or more generally, the example virtual networking layer 160 of FIG. 2 is/are hereby expressly defined to include a non-transitory computer readable storage device or storage disk such as a memory, a digital versatile disk (DVD), a compact disk (CD), a Blu-ray disk, etc. including the software and/or firmware. Further still, the example virtual networking layer 160 of FIG. 1 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

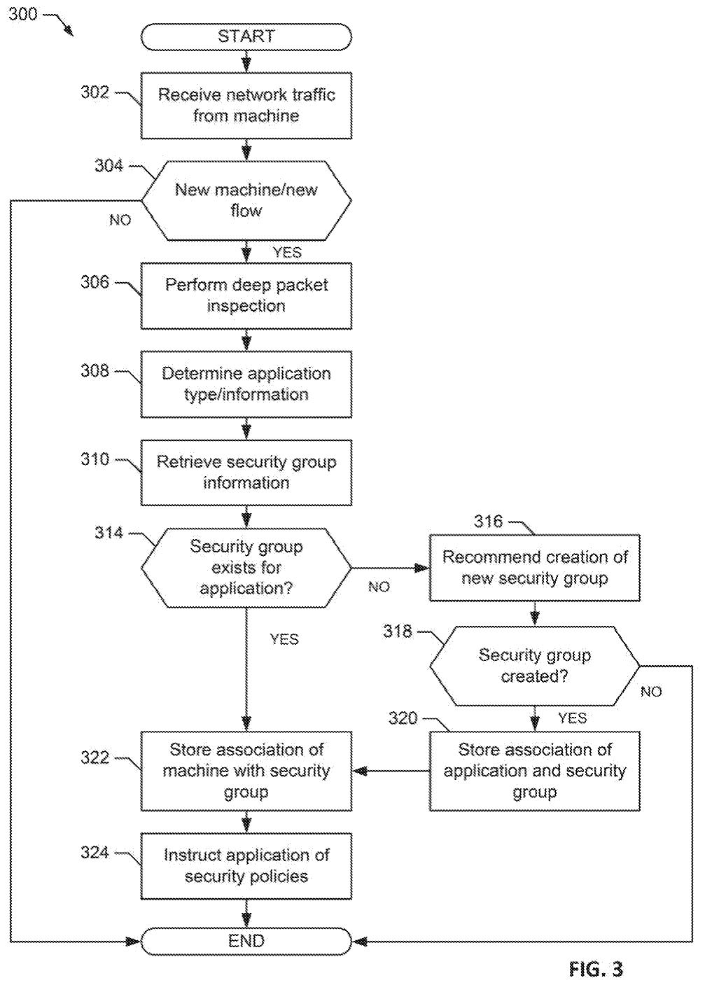

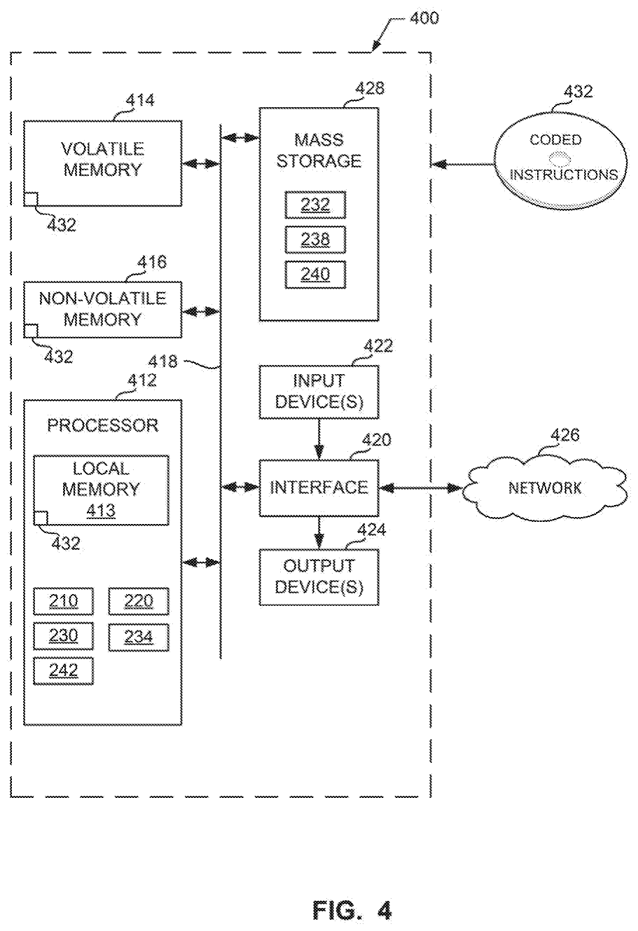

A flowchart representative of example hardware logic or machine readable instructions for implementing the virtual networking layer 160 of FIG. 1 and/or FIG. 2 is shown in FIG. 3. The machine readable instructions may be a program or portion of a program for execution by a processor such as the processor 412 shown in the example processor platform 400 discussed below in connection with FIG. 4. The program may be embodied in software stored on a non-transitory computer readable storage medium such as a CD-ROM, a floppy disk, a hard drive, a DVD, a Blu-ray disk, or a memory associated with the processor 412, but the entire program and/or parts thereof could alternatively be executed by a device other than the processor 412 and/or embodied in firmware or dedicated hardware. Further, although the example program is described with reference to the flowchart illustrated in FIG. 3 many other methods of implementing the example virtual networking layer 160 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIG. 3 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, and (6) B with C.

The program 300 of FIG. 3 begins at block 302 when the firewall engine 220 receives network traffic from a computing element (e.g., the virtual machine 114) (block 302). The example, firewall engine 220 determines if the traffic is from a new computing element (e.g., a computing element that has not previously transmitted traffic) and/or the traffic is from a new communication flow (e.g., a new connection) (block 304). Alternatively or additionally, the firewall engine 220 may periodically analyze traffic from a previously seen computing element to determine if an application of the computing element has changed. For example, traffic from a machine may be re-analyzed hourly, daily, weekly, monthly, etc. For example, the virtual machine 114 may provide a database service at a first time and may be later changed to provide a web service. When the computing element is not a new machine and/or the traffic is not a new flow, the process of FIG. 3 ends. For example, the traffic may continue to be handled by a previously assigned security policy and the process 300 will not change the security policies enforce for the computing element.

When the computing element is new (e.g., traffic has not previously been analyzed to determine an application) or the traffic is a new flow (block 304), the example deep packet inspector 230 performs deep packet inspection to identify information about the packets of the traffic (e.g., to identify an application identifier, an application protocol, etc.) (block 306). For example, the deep packet inspector 230 may identify an application identifier (e.g., App ID). The example security controller 234 queries the example application database 232 using the information determined from the deep packet inspection to determine an application on a computing element that transmitted the traffic (block 308).

The example security controller 234 attempts to retrieve security group information for the identified application from the example application to security group database 238 (block 310). The example security controller 234 determines if a security group exists for the identified application (block 314). When the example security controller 234 determines that a security group does not exist, the security controller 234 recommends creation of a new security group via the user interface 242 (block 316)

The security controller 234 determines if a new security group for creation has been received (block 318). When a new security group has not been created, the process 300 of FIG. 3 ends. When a new security group has been created, the example security controller 234 stores an association of the application and the security group in the example application to security group database (block 320).

After determining that a security group exists for a new application (block 314) or storing an association for a new security group (block 320), the example security controller 234 stores an association of the computing element and the security group (block 322). Then example security controller 234 then instructs the firewall engine 220 to apply policies of the security group to traffic from the identified computing element (block 324). The security controller 234 may additionally or alternatively apply security policies from the security group to any other element of a computing system (e.g., a storage controller, a network controller, etc.).

FIG. 4 is a block diagram of an example processor platform 400 structured to execute the instructions of FIG. 4 to implement the virtual networking layer 160 of FIG. 1 and/or FIG. 2. The processor platform 400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 400 of the illustrated example includes a processor 412. The processor 412 of the illustrated example is hardware. For example, the processor 412 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example software forwarding element 210, the example firewall engine 220, the example deep packet inspector 230, the example security controller 234, and the example user interface 242.

The processor 412 of the illustrated example includes a local memory 413 (e.g., a cache). The processor 412 of the illustrated example is in communication with a main memory including a volatile memory 414 and a non-volatile memory 416 via a bus 418. The volatile memory 414 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 416 may be implemented by flash memory and/or any other desired type of memory device. Access to the main memory 414, 416 is controlled by a memory controller.

The processor platform 400 of the illustrated example also includes an interface circuit 420. The interface circuit 420 may be implemented by any type of interface standard, such as an Ethernet interface, a universal serial bus (USB), a Bluetooth® interface, a near field communication (NFC) interface, and/or a PCI express interface.

In the illustrated example, one or more input devices 422 are connected to the interface circuit 420. The input device(s) 422 permit(s) a user to enter data and/or commands into the processor 412. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 424 are also connected to the interface circuit 420 of the illustrated example. The output devices 424 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 420 of the illustrated example, thus, typically includes a graphics driver card, a graphics driver chip and/or a graphics driver processor.

The interface circuit 420 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 426. The communication can be via, for example, an Ethernet connection, a digital subscriber line (DSL) connection, a telephone line connection, a coaxial cable system, a satellite system, a line-of-site wireless system, a cellular telephone system, etc.

The processor platform 400 of the illustrated example also includes one or more mass storage devices 428 for storing software and/or data. Examples of such mass storage devices 428 include floppy disk drives, hard drive disks, compact disk drives, Blu-ray disk drives, redundant array of independent disks (RAID) systems, and digital versatile disk (DVD) drives. The example mass storage 428 includes the example application database 232, the example application to security group database 238, and the example machine database 240.

The machine executable instructions 432 of FIG. 3 may be stored in the mass storage device 428, in the volatile memory 414, in the non-volatile memory 416, and/or on a removable non-transitory computer readable storage medium such as a CD or DVD.

From the foregoing, it will be appreciated that example methods, apparatus and articles of manufacture have been disclosed that improve the assignment of security policies to computing elements in a networked computing environment by determining an application of a computing element and assigning security policies based on the application determined for the computing element. In some examples, when a security policy has not been previously assigned to the application, a recommendation is presented to a user (e.g., an administrator) to create a security policy. In some examples, the use of deep packet inspection to identify an application on a computing element reduces computational complexity and memory resource requirements of the computing element by eliminating the need for an agent to execute on the computing element to identify the application as is common in prior systems.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus comprising:
a deep packet inspector to:
analyze a network communication from a virtual machine in a software defined network environment to determine an identifier of an application;
a security controller to:
determine an application type executing on the virtual machine;
determine if a security group exists for the application type; and
a user interface to present a recommendation to create a security group for the application type when a security group for the application type does not exist.

2. An apparatus as defined in claim 1, wherein the security controller is further to add the virtual machine to the security group when the security group exists for the application type.

3. An apparatus as defined in claim 1, wherein the deep packet inspector is to determine an application identifier associated with the application.

4. An apparatus as defined in claim 3, wherein the deep packet inspector is to retrieve the application identifier from the network communication while the network communication is processing by a firewall.

5. An apparatus as defined in claim 1, wherein the deep packet inspector is to analyze a further network communication from the virtual machine when the network communication is from a new session.

6. An apparatus as defined in claim 1, wherein the deep packet inspector is implemented within a software defined network.

7. An apparatus as defined in claim 6, further including a software forwarding element to implement a virtual switch for transferring traffic including the network communication within the software defined network.

8. A non-transitory computer readable medium comprising instructions that,
when executed cause a machine to at least:
analyze, using deep packet inspection, a network communication from a virtual machine in a software defined network environment to determine an identifier of an application; and
determine an application type executing on the virtual machine;
determine if a security group exists for the application type; and
present a recommendation to create a security group for the application type when a security group for the application type does not exist.

9. A non-transitory computer readable medium as defined in claim 8, wherein the instructions, when executed, cause the machine to add the virtual machine to the security group when the security group exists for the application type.

10. A non-transitory computer readable medium as defined in claim 8, wherein the instructions, when executed, cause the machine to determine an application identifier associated with the application.

11. A non-transitory computer readable medium as defined in claim 10, wherein the instructions, when executed, cause the machine to retrieve the application identifier from the network communication while the network communication is processing by a firewall.

12. A non-transitory computer readable medium as defined in claim 8, wherein the instructions, when executed, cause the machine to analyze a further network communication from the virtual machine when the network communication is from a new session.

13. A non-transitory computer readable medium as defined in claim 8, wherein the network communication is transferred within a software defined network.

14. A non-transitory computer readable medium as defined in claim 13, wherein the instructions, when executed, cause the machine to implement a virtual switch for transferring traffic including the network communication within the software defined network.

15. A method comprising:
analyzing a network communication from a virtual machine in a software defined network environment to determine an identifier of an application;
determining an application type executing on the virtual machine;
determining if a security group exists for the application type; and
presenting a recommendation to create a security group for the application type when a security group for the application type does not exist.

16. A method as defined in claim 15, further including adding the virtual machine to the security group when the security group exists for the application type.

17. A method as defined in claim 15, further including adding an application identifier associated with the application.

18. A method as defined in claim 17, further including retrieving the application identifier from the network communication while the network communication is processing by a firewall.

19. A method as defined in claim 15, further including analyzing a further network communication from the virtual machine when the network communication is from a new session.

20. A method as defined in claim 15, wherein the network communication is transferred within a software defined network.

21. A method as defined in claim 20, further including implementing a virtual switch for transferring traffic including the network communication within the software defined network.
